(19) United States
(12) Patent Application Publication
(10) Pub. No.: US 2026/0124083 A1
(43) Pub. Date: May 7, 2026

(54) Frame for a wheelchair

(71) Applicant: Sylvan LLC, Myrtle Beach, SC (US)

(72) Inventor: Sylvan Newby, N. Myrtle Beach, SC (US)

(73) Assignee: Sylvan LLC, Myrtle Beach, SC (US)

(21) Appl. No.: 19/383,161

(22) Filed: Nov. 7, 2025

Related U.S. Application Data
(60) Provisional application No. 63/717,846, filed on Nov. 7, 2024.

(51) Int. Cl. A61G 5/08; A61G 5/10; A61G 5/12

(52) U.S. Cl. CPC A61G 5/0825; A61G 5/0883; A61G 5/101; A61G 5/1016; A61G 5/1018; A61G 5/1035; A61G 5/121; A61G 5/128

(57) ABSTRACT

Disclosed is a folding wheelchair having a plurality of support members each having a first and a second end, a first separation distance measured between the respective first ends of a second support member and a fourth support member, a second separation distance measured between the respective second ends of the second support member and a fourth support member, a third separation distance measured between the respective first ends of the first support member and the third support member, wherein the wheelchair can be disposed in an open position and a folded position and, in the open position, the first separation distance is shorter than the second separation distance, the first separation distance is shorter than the third separation distance, and the second separation distance is shorter than the third separation distance. An intersection angle of the second and fifth support members is less than 55 degrees.

### BACKGROUND OF THE INVENTION

This application is a non-provisional of U.S. Provisional Application 63/717,846 filed Nov. 7, 2024 the entirety of which is hereby incorporated by reference. Field of the Invention

The embodiments of the invention relate to wheelchairs, and more particularly, to a design of frame and a headrest for a folding wheelchair. Although embodiments of the invention are suitable for a wide scope of applications, it is particularly suitable for strollers for adults.

### DISCUSSION OF THE RELATED ART

Wheelchairs serve as mobility devices for individuals with various physical limitations, enabling them to navigate their environment with greater independence. Traditional wheelchair designs have evolved over many decades to address different user needs, ranging from basic transportation to specialized applications for sports and outdoor activities. The design requirements for wheelchairs vary significantly depending on the intended use environment, with indoor models typically prioritizing maneuverability and compact dimensions, while outdoor models may emphasize durability and stability over varied terrain. Modern wheelchair users often require devices that can accommodate multiple environments and usage scenarios, creating demand for versatile designs that maintain performance across different conditions.

One ongoing challenge in wheelchair design involves balancing structural stability with portability. Many users require wheelchairs that can be easily transported or stored when not in use, leading to the development of folding mechanisms that allow the frame to collapse into a more compact configuration. However, folding mechanisms can introduce potential points of weakness or instability in the overall frame structure. The complexity of folding systems can also affect the overall weight of the wheelchair, as additional hardware and reinforcement may be required to maintain structural integrity at pivot points and connection interfaces. Furthermore, repeated folding and unfolding cycles can lead to wear at joint locations, potentially compromising the long-term reliability of the wheelchair frame if not properly designed and manufactured.

Urban environments present particular challenges for wheelchair users, including navigating curbs, uneven pavement surfaces, and various obstacles that may be encountered on sidewalks and streets. These conditions place additional stress on wheelchair frames and can affect the overall durability and performance of the mobility device. The frame must be capable of withstanding these stresses while maintaining structural integrity over extended periods of use.

The materials and construction methods used in wheelchair frames also play a role in determining the overall weight, strength, and cost of the final product. Manufacturers continue to explore different approaches to frame design that can provide adequate strength and stability while keeping the wheelchair lightweight and maneuverable for the user.

Storage and transportation considerations are particularly relevant for users who travel frequently or have limited storage space in their homes or vehicles. The ability to quickly and easily fold a wheelchair for storage or transport can greatly enhance the user's mobility and independence in various situations.

### SUMMARY OF THE INVENTION

Accordingly, embodiments of the invention are directed to a frame for a wheelchair that substantially obviates one or more of the problems due to limitations and disadvantages of the related art.

An object of embodiments of the invention is to provide a wheelchair suitable as an adult activity chair.

Another object of embodiments of the invention is to provide a wheelchair having a stable base suitable for urban terrain.

Yet another object of embodiments of the invention is to provide a wheel chair that is collapsible.

Still another object of embodiments of the invention is to provide a wheelchair that is lightweight.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, frame for a wheelchair includes a headrest for insertion into a seatback pocket of a wheelchair, an insertion portion for insertion into the seatback pocket, an extension portion for extending out of the seatback pocket for cradling a user's head, a transition portion between the insertion portion and the extension portion, a first curvature of the insertion portion, the first curvature sized in relative proportions to match a user's back, a second curvature of the extension portion, the second curvature sized in relative proportions to match a user's head, and the first curvature and the second curvature are different.

In another aspect, frame for a wheelchair includes a wheelchair having a plurality of support members each having a first and a second end, a first separation distance measured between the respective first ends of a second support member and a fourth support member, a second separation distance measured between the respective second ends of the second support member and a fourth support member, a third separation distance measured between the respective first ends of the first support member and the third support member, wherein the wheelchair can be disposed in an open position and a folded position and, in the open position, the first separation distance is shorter than the second separation distance, the first separation distance is shorter than the third separation distance, and the second separation distance is shorter than the third separation distance. An intersection angle measured at an intersection of the second and fifth support members is less than 55 degrees.

In yet another aspect, frame for a wheelchair includes a head support frame, an insertion portion of the head support frame, a head support portion of the head support frame, a seat back of the wheelchair, a pocket in the seat back, the pocket sized in relative proportions to slidably receive the insertion portion of the head support frame, a padded member covering the head support portion of the head support frame, a first contour of the insertion portion, the first contour sized in approximate proportions to a human back, a second contour of the head support portion, the second contour sized in approximate proportions to a human head; and the first contour and the second contour are different.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is an isometric drawing of a wheelchair according to an exemplary embodiment of the invention;

FIG. 2 is an isometric drawing of a wheelchair according to an exemplary embodiment of the invention;

FIG. 3 is an isometric drawing of a headrest for a wheelchair.

FIG. 4 is an isometric drawing of a wheelchair according to an exemplary embodiment of the invention;

FIG. 5 is a detail of a rear lower portion of a wheelchair according to an exemplary embodiment of the invention;

FIG. 6 is an isometric drawing of a wheelchair according to an exemplary embodiment of the invention;

FIG. 7 is an isometric drawing of a wheelchair according to an exemplary embodiment of the invention; and

FIG. 8 is an isometric drawing of a wheelchair according to an exemplary embodiment of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

The wheelchair depicted in the drawings is of the style commonly known as an adult activity chair. Adult activity chairs represent a specialized category of mobility devices designed to accommodate the unique needs of adult users who require wheelchair assistance but may not fit comfortably in standard pediatric strollers or traditional wheelchairs. These chairs are particularly beneficial for adults with developmental disabilities, cognitive impairments, or physical limitations who benefit from the security and support provided by a stroller-like seating arrangement while maintaining the dignity appropriate for adult users.

The design characteristics of adult activity chairs typically include larger frame dimensions to accommodate adult body proportions, higher weight capacity ratings compared to pediatric equipment, and enhanced structural reinforcement to withstand the increased loads associated with adult use. The seating surfaces and backrest areas are proportioned to provide appropriate support for adult users while maintaining comfort during extended periods of use.

Adult activity chairs often incorporate features that address the specific mobility challenges faced by adult users with disabilities, including enhanced postural support systems, adjustable components to accommodate varying user needs, and safety features designed for adult supervision scenarios. The folding mechanism described in the present invention provides particular advantages for adult activity chair applications, as caregivers and family members frequently need to transport these devices in standard passenger vehicles or store them in residential settings where space may be limited.

The market for adult activity chairs has grown significantly as awareness of the mobility needs of adults with disabilities has increased, and as the population of individuals aging with lifelong disabilities continues to expand. Traditional wheelchair designs may not always provide the optimal combination of support, security, and ease of use required by this user population, making specialized adult activity chairs an important category within the broader mobility device market.

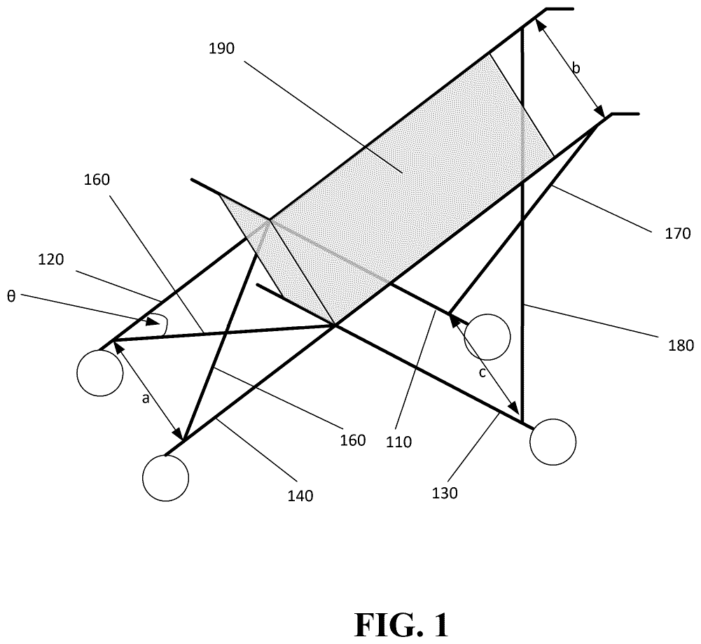

FIG. 1 is an isometric drawing of a wheelchair according to an exemplary embodiment of the invention. As shown in FIG. 1, a frame for a wheelchair can be formed from support members 110, 120, 130, 140, 141, 150, 160, 170, and 180. Distance (a) can denote the distance between lower ends of support members 120 and 140. Distance (b) can denote the distance between upper ends of support members 120 and 140. Distance (c) can denote the distance between lower ends of support members 110 and 130. Angle (θ) can denote the angle between support members 120 and 160.

The frame can be covered with a fabric material to form a seat 190. The fabric material can be a durable, weather-resistant textile suitable for outdoor use and capable of supporting the weight of an adult user. In some embodiments, the fabric material can be a canvas, nylon, or polyester blend that provides both comfort and longevity. The fabric can be attached to the frame using conventional fastening methods such as snaps, Velcro, grommets, or sewn sleeves that allow the fabric to be stretched across the support members.

The seat 190 formed by the fabric material can include both a seating surface and a backrest portion. The fabric can be configured to provide appropriate tension when the wheelchair is in the open position, creating a stable and comfortable seating surface. When the wheelchair is folded into the closed position, the fabric material can collapse along with the frame structure without interfering with the folding mechanism.

In preferred embodiments, the fabric material can be removable from the frame to allow for cleaning or replacement. The fabric can also include reinforced areas at high-stress points where it contacts the support members to prevent premature wear or tearing. Additionally, the fabric material can be treated with water-resistant or antimicrobial coatings to enhance its suitability for various environmental conditions and maintain hygiene during extended use.

The support members of the frame can be formed from tubular steel. The tubular steel construction provides an optimal balance of strength, weight, and durability for wheelchair applications. The hollow tubular design offers superior strength-to-weight ratio compared to solid steel members, while maintaining the structural integrity necessary to support the dynamic loads encountered during wheelchair use. The steel tubing can have a wall thickness ranging from approximately 1.0 mm to 3.0 mm, depending on the specific support member and its load-bearing requirements within the frame structure.

In preferred embodiments, the tubular steel can be formed from high-strength low-alloy steel or carbon steel that meets applicable industry standards for wheelchair construction. The steel tubing can have an outer diameter ranging from approximately 15 mm to 30 mm, with the specific dimensions selected based on the structural requirements of each support member's position and function within the overall frame assembly.

The tubular steel members can be treated with corrosion-resistant coatings such as powder coating, anodizing, or galvanization to enhance durability and weather resistance. These protective finishes also provide aesthetic appeal and can be applied in various colors to meet user preferences or visibility requirements.

Alternative materials for the support members can include aluminum alloy tubing, which offers reduced weight compared to steel while maintaining adequate strength for many applications. Carbon fiber composite tubing can also be employed in premium embodiments where weight reduction is a primary concern, though such materials may increase manufacturing costs. Stainless steel tubing can be used in applications where enhanced corrosion resistance is required, such as for wheelchairs intended for marine environments or areas with high humidity.

The connection points between tubular steel members can be reinforced with additional material or specialized joint designs to distribute stress concentrations that occur at pivot points and sliding interfaces. Bushings, bearings, or other wear-resistant components can be incorporated at connection points to ensure smooth operation of the folding mechanism over extended use cycles.

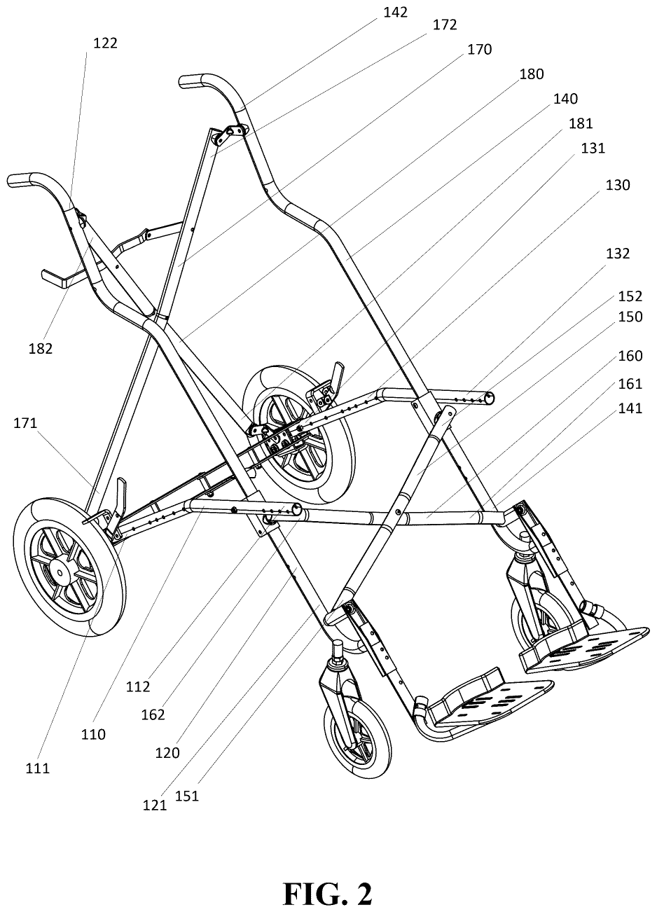

FIG. 2 is an isometric drawing of a wheelchair according to an exemplary embodiment of the invention. As shown in FIG. 2, frame for a wheelchair can be formed from support members 110, 120, 130, 140, 141, 150, 160, 170, and 180. Each support member can have a first end nearest the ground 111, 121, 131, 141, 141, 151, 161, 171, and 181, respectively. Each support member can have a second 112, 122, 132, 142, 141, 152, 162, 172, and 182 opposite their respective first ends.

Support member 110 can be rotably connected to the support member 170. Support member 110 can be slidably connected to support member 120 and support member 160. Support member 120 can be rotably connected to the support member 150 and support member 180. Support member 130 can be slidably connected to the support member 140 and support member 150. Support member 130 can be rotably connected to support member 180. Support member 140 can be rotably connected to support member 160 and support member 170. Support member 150 can be rotably connected to support member 160. Support member 170 can be rotably connected to support member 180.

The wheelchair can be disposed in an open position (as shown) or a closed position. In a closed position, the support members are collapsed about their respective rotating and sliding connects. The collapsed position can be advantageous for travel and storage.

In the closed position, the overall footprint of the wheelchair is significantly reduced, making it suitable for storage in confined spaces such as vehicle trunks, closets, or under beds. The collapsed configuration typically reduces the wheelchair's width by approximately 60-70% compared to the open position, while maintaining a relatively flat profile that facilitates stacking or placement against walls. The folding mechanism is designed to be operated by a single user without requiring excessive force or complex manipulation sequences.

The transition between open and closed positions can typically be accomplished in less than 30 seconds by an experienced user, making the wheelchair practical for frequent folding and deployment cycles. The folding mechanism is designed to withstand repeated use over the expected lifetime of the wheelchair without significant wear or degradation of the connection points.

A distance (a) can between ends 121 and 141 can be less than a distance (b) between ends 122 and 142. A distance (a) can between ends 121 and 141 can be less than a distance (c) between ends 111 and 131. A distance (b) between ends 122 and 142 can be shorter than a distance (c) between ends 111 and 131. Intersection angle (θ) between ends 121 and 151 can measure the relative angle between the connection of support members 120 and 150. Intersection angle (θ) can be less than 55 degrees when the wheelchair is in the open position and preferably 52 degrees. The intersection angle (θ) is preferably selected to provide crosswise rigidity while also providing a “breakable” angle to support the folding of the wheelchair. The relative dimensions of distances (a), (b), and (c) can be beneficial to provide a stable base for the wheelchair while simultaneously being nimble and easy to maneuver.

A wheelchair can have wheels. The wheelchair can include four wheels: two larger rear wheels and two smaller front wheels, though alternative wheel configurations can be employed depending on the specific application and user requirements. The rear wheels are generally larger in diameter, typically ranging from 6 to 10 inches.

The front wheels, commonly referred to as caster wheels, are typically smaller in diameter, ranging from 4 to 8 inches, and are mounted on swiveling assemblies that allow for steering and maneuverability. The caster wheels can rotate 360 degrees about their vertical mounting axis, enabling the wheelchair to turn in tight spaces and navigate around obstacles. The size and type of caster wheels can be selected based on the intended operating environment, with larger casters generally providing better performance over rough surfaces and smaller casters offering improved maneuverability on smooth surfaces.

The wheels can be equipped with pneumatic tires, solid rubber tires, or foam-filled tires depending on the intended use environment and user preferences. Pneumatic tires provide superior shock absorption and ride comfort, particularly when traversing uneven surfaces, but require periodic maintenance to maintain proper inflation pressure. Solid rubber tires eliminate the risk of punctures and require minimal maintenance, though they may transmit more vibration and impact forces to the user. Foam-filled tires offer a compromise between pneumatic and solid tires, providing some shock absorption while eliminating puncture concerns.

The wheel mounting system is designed to integrate with the folding mechanism of the wheelchair frame. The rear wheels can be equipped with quick-release mechanisms that allow for easy removal for transportation or storage. These quick-release systems typically employ cam-operated or spring-loaded mechanisms that secure the wheel to the axle while allowing for tool-free removal when desired. The front caster assemblies are designed to fold or collapse along with the frame structure during the folding process.

Wheel bearings are incorporated at all rotating interfaces to ensure smooth operation and minimize rolling resistance. The bearings can be sealed ball bearings or roller bearings selected for their load capacity, durability, and resistance to environmental contamination. Proper bearing selection and maintenance are critical for ensuring long-term performance and minimizing the effort required for wheelchair propulsion.

The wheel track width and wheelbase dimensions are optimized to provide stability while maintaining maneuverability. The rear wheel track width typically ranges from 20 to 34 inches, providing adequate stability for the wheelchair while allowing passage through standard doorways and accessibility openings. The wheelbase, measured from the rear axle to the front caster pivot point, is selected to balance stability and turning radius requirements.

The wheelchair can have foot supports. The foot supports, also commonly referred to as footrests or footplates, provide a stable platform for the user's feet during wheelchair operation and help maintain proper posture and comfort during extended periods of use. The foot supports can be positioned at an appropriate height and angle to accommodate the user's leg length and preferred seating position while ensuring that the user's feet are properly supported and do not drag on the ground during wheelchair movement.

In preferred embodiments, the foot supports can be adjustable to accommodate users of different heights and leg lengths. The adjustment mechanism can include telescoping tubes, multiple mounting holes, or sliding brackets that allow the foot support height to be modified without requiring tools. The adjustment range typically spans approximately 4 to 8 inches to accommodate the majority of adult users while maintaining structural integrity and stability of the foot support assembly.

The foot supports can be designed to fold or swing away from the wheelchair frame to facilitate user transfers and reduce the overall footprint of the wheelchair when folded. The folding mechanism can include spring-loaded hinges or manual release levers that allow the foot supports to be quickly repositioned without interfering with the wheelchair's primary folding sequence. When folded upward or swung to the side, the foot supports should not extend beyond the overall envelope of the collapsed wheelchair frame.

The foot support platforms themselves can be formed from lightweight materials such as aluminum, reinforced plastic, or composite materials that provide adequate strength while minimizing weight contribution to the overall wheelchair assembly. The platform surface can include anti-slip texturing, rubber pads, or other traction-enhancing features to prevent the user's feet from sliding during wheelchair operation. The platform dimensions are typically sized to accommodate standard adult footwear while maintaining a compact profile that does not interfere with wheelchair maneuverability.

In some embodiments, the foot supports can include heel loops or toe straps to help secure the user's feet in position, particularly for users with limited lower extremity control or sensation. These retention features can be adjustable or removable based on individual user needs and preferences. The foot supports can also incorporate angle adjustment capabilities to optimize the user's leg and ankle positioning for comfort and circulation.

The mounting system for the foot supports is designed to integrate with the wheelchair's folding mechanism while providing secure attachment to the frame structure. The mounting points are typically reinforced to handle the loads transmitted through the foot supports during normal wheelchair operation, including dynamic loads encountered when traversing uneven surfaces or obstacles.

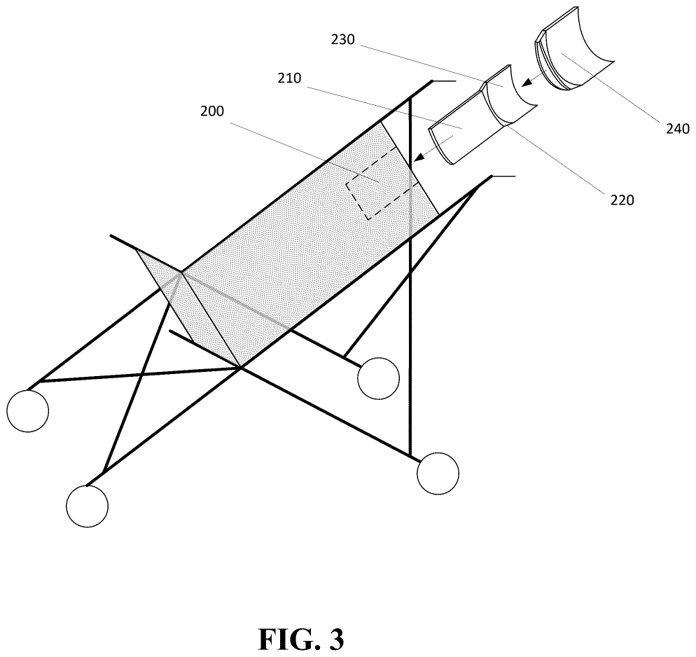

FIG. 3 is an isometric drawing of a headrest for a wheelchair. As shown in FIG. 3, a seatback of the wheelchair can have a pocket 200. A headrest can be disposed in relative proportions to be slidably inserted into the pocket 200. The headrest can have an insertion portion 210, a transition portion 220, and a head supporting portion 230. The insertion portion 210 can have a curvature to match a human back. The head supporting portion 230 can have a curvature to match a human head. The curvature of the two portions 210 and 230 can be different. The curvature of the insertion portion 210 can be flatter than the head supporting portion 230. The headrest can have a removable pad 240 that is sized in relative proportions to cover the head supporting portion 230.

The removable pad 240 can be formed from memory foam, polyurethane foam, or gel-infused cushioning materials that provide comfort and pressure distribution for the user's head and neck area. The removable pad 240 is designed to be easily detached from the head supporting portion 230 for cleaning, replacement, or customization based on individual user preferences and hygiene requirements.

In preferred embodiments, the removable pad 240 can be constructed with a multi-layer design that includes a firm base layer for structural support and a softer surface layer for user comfort. The base layer can be formed from medium-density foam that maintains its shape under load while providing adequate support for the user's head positioning. The surface layer can be formed from softer materials such as memory foam or gel-infused foam that conforms to the user's head contours and provides pressure relief during extended periods of use.

The removable pad 240 can be covered with a fabric covering that is both durable and easy to clean. Suitable fabric materials include vinyl, leather, or synthetic leather that can be wiped clean with standard disinfectants, making the headrest suitable for institutional use or shared equipment scenarios. Alternatively, the fabric covering can be formed from breathable materials such as mesh or perforated synthetic materials that promote air circulation and reduce heat buildup during extended use.

The attachment mechanism for the removable pad 240 can include hook-and-loop fasteners, snaps, or elastic straps that secure the pad to the head supporting portion 230 while allowing for quick removal when needed. The attachment system is designed to maintain secure positioning of the pad during normal use while preventing shifting or displacement that could compromise user comfort or safety. The pad can also include reinforced attachment points that distribute the securing forces evenly across the pad structure to prevent premature wear or tearing at the connection interfaces.

In some embodiments, multiple removable pads 240 of different thicknesses or firmness levels can be provided to accommodate varying user preferences or medical requirements. This modular approach allows caregivers or users to customize the headrest configuration based on individual needs while maintaining the same basic headrest frame structure.

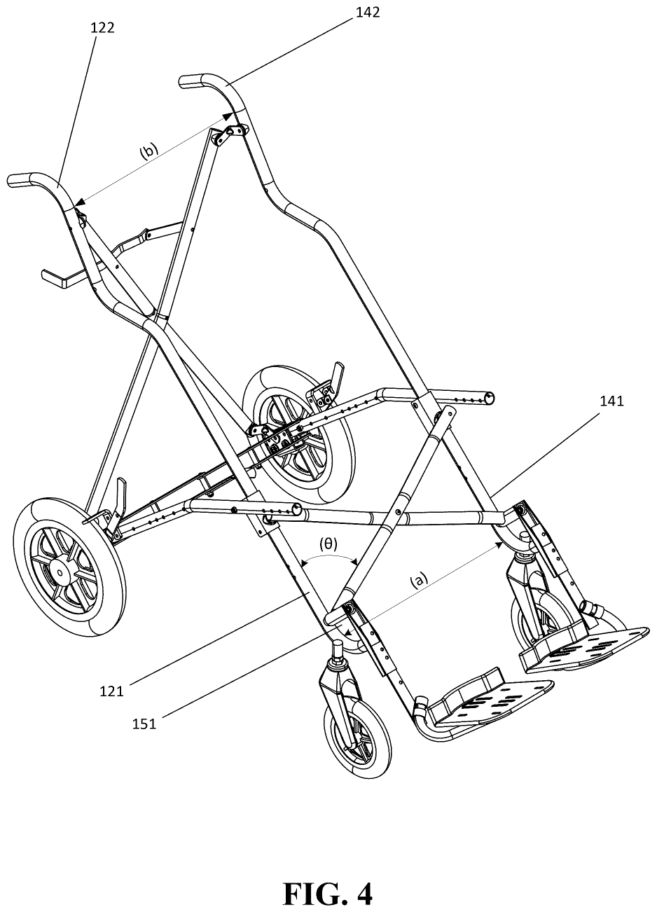

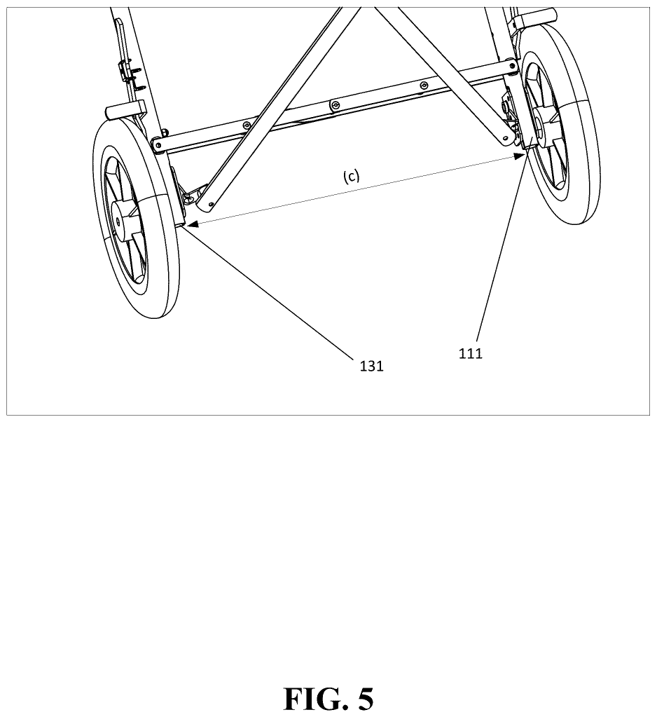

FIG. 4 is an isometric drawing of a wheelchair according to an exemplary embodiment of the invention and FIG. 5 is a detail of a rear lower portion of a wheelchair according to an exemplary embodiment of the invention. As shown in FIG. 4 and FIG. 5, support members can have separation distances noted as (a), (b), and (c). Distance (a) can be measured between ends 121 and 141. Distance (b) can be measured between ends 122 and 142. Distance (c) can be measured between ends 131 and 111. Additionally, support members can be disposed at relative angles (θ).

In preferred embodiments of the invention, in the open position, distance (a) between ends 121 and 141 can be less than a distance (b) between ends 122 and 142, distance (a) between ends 121 and 141 can be less than a distance (c) between ends 111 and 131, and distance (b) between ends 122 and 142 can be shorter than a distance (c) between ends 111 and 131. An intersection angle (θ) between ends 121 and 151 can be less than 55 degrees when the wheelchair is in the open position. Intersection angle (θ) is preferably 52 degrees.

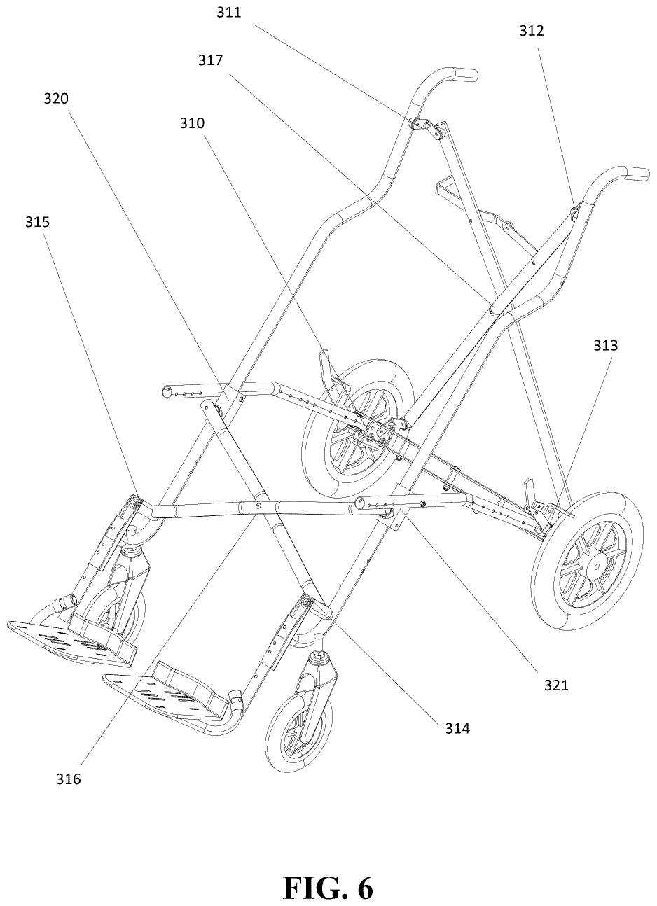

FIG. 6 is an isometric drawing of a wheelchair according to an exemplary embodiment of the invention. As shown in FIG. 6, a wheelchair can have rotating connection points 310, 311, 312, 313, 314, 315, 316, and 317. A wheelchair can have compound sliding and rotating members 320 and 321. With reference to FIG. 2, and FIG. 6, compound sliding and rotating member 320 can join support members 110, 120, and 160. Compound sliding and rotating member 321 can join support members 130, 140. And 150.

Rotating connection points 310, 311, 312, 313, 314, 315, 316, and 317 can be rivets or bolts. The selection between rivets and bolts depends on the specific design requirements and manufacturing considerations for each connection point. Rivets provide a permanent connection that cannot be easily disassembled, offering excellent strength characteristics and resistance to loosening under repeated stress cycles. Aluminum or steel rivets can be used depending on the material composition of the support members, with the rivet material typically selected to match or complement the support member material to prevent galvanic corrosion.

Bolts, alternatively, provide the advantage of serviceability, allowing for disassembly of the wheelchair frame for maintenance, repair, or replacement of components. When bolts are employed, they are typically secured with lock washers, thread-locking compounds, or self-locking nuts to prevent loosening during normal operation. The bolt diameter and thread pitch are selected to provide adequate shear and tensile strength for the expected loads at each connection point.

In preferred embodiments, the rotating connection points can incorporate bushings or bearings to reduce friction and wear during the folding and unfolding operations. These bushings can be formed from bronze, nylon, or other low-friction materials that provide smooth rotation while maintaining dimensional stability over extended use cycles. The bushings also serve to distribute loads more evenly across the connection interface, reducing stress concentrations that could lead to premature failure.

The rotating connection points are designed to accommodate the angular movement required during the folding sequence while maintaining structural integrity in both the open and closed positions. Each connection point is engineered to withstand the specific load conditions encountered at its location within the frame assembly, including both static loads from user weight and dynamic loads from wheelchair operation and folding cycles.

Compound sliding and rotating members 320 and 321 can be folded sheet metal lined with a low friction material such as plastic. The folded sheet metal construction provides a lightweight yet durable housing that can withstand the repeated stresses encountered during folding and unfolding cycles. The sheet metal is typically formed from aluminum or steel alloy with a thickness ranging from approximately 1.0 mm to 2.0 mm, providing adequate strength while maintaining minimal weight contribution to the overall wheelchair assembly.

The folding process for the sheet metal involves precision bending operations that create the necessary internal geometry to accommodate the sliding and rotating functions of the support members. The folded edges of the sheet metal are typically deburred and finished to eliminate sharp edges that could cause injury during operation or maintenance. The internal surfaces of the folded sheet metal housing are configured to provide smooth, continuous pathways for the sliding motion of the support members.

The low friction material lining serves multiple critical functions within the compound sliding and rotating members. Plastic materials such as ultra-high molecular weight polyethylene (UHMWPE), nylon, or polytetrafluoroethylene (PTFE) can be employed as the lining material. These materials exhibit excellent wear resistance and low coefficients of friction, typically ranging from 0.1 to 0.3 depending on the specific plastic formulation and surface treatment.

The plastic lining is bonded or mechanically fastened to the interior surfaces of the folded sheet metal housing using adhesives, mechanical fasteners, or interference fit installation methods. The thickness of the plastic lining typically ranges from 0.5 mm to 2.0 mm, providing adequate cushioning and wear protection while maintaining precise dimensional tolerances for the sliding interfaces. The lining material is selected to maintain its properties across the expected operating temperature range and environmental conditions encountered during wheelchair use.

In preferred embodiments, the plastic lining can include molded or machined features such as grooves, channels, or bearing surfaces that guide the movement of the support members and distribute contact stresses more evenly. These features help to ensure smooth operation throughout the folding mechanism's operational life while minimizing maintenance requirements. The plastic lining can also incorporate self-lubricating properties or be treated with dry lubricants to further reduce friction and wear at the sliding interfaces.

When transitioning between an open position and a folded or closed position, compound sliding and rotating member 320 can slide up and down support member 120 while support members 110 and 160 rotate. When transitioning between an open position and a folded or closed position, compound sliding and rotating member 321 can slide up and down support member 140 while support members 130 and 150 rotate.

The folding mechanism allows the wheelchair to transition smoothly between the open and closed positions through a coordinated sequence of rotational and sliding movements of the support members. During the folding process, the compound sliding and rotating members 320 and 321 (FIG. 6) facilitate the controlled collapse of the frame structure by allowing certain support members to slide along predetermined paths while others rotate about their connection points. This dual-motion system ensures that the frame maintains structural integrity throughout the folding sequence while achieving maximum compactness in the closed position.

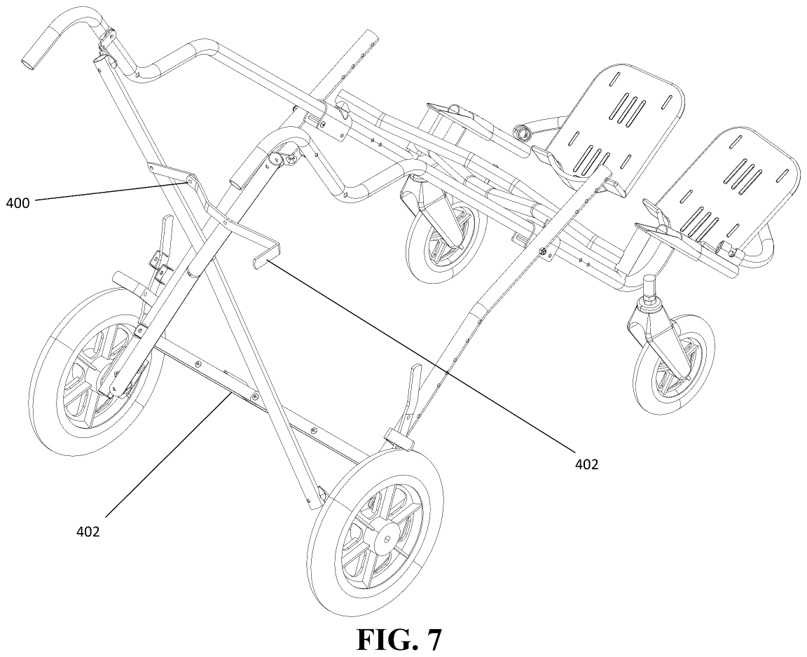

FIG. 7 is an isometric drawing of a wheelchair according to an exemplary embodiment of the invention. As shown in FIG. 7, a wheelchair can have frame locking members 400 and 402. Frame locking members 400 and 402 can hingedly collapse to allow the wheelchair to fold. Alternatively, frame locking members 400 and 402 can be extended to lock the wheelchair in an open position. Frame locking members 400 can have a handle.

The frame locking members 400 and 402 can secure the wheelchair in both the open and closed positions. When transitioning to the closed position, these locking members can be disengaged to allow free movement of the support members during folding. Once the desired position is achieved, the locking members can be re-engaged to prevent unintended movement or deployment of the frame. This locking system provides safety assurance during transportation and storage by preventing accidental opening of the wheelchair.

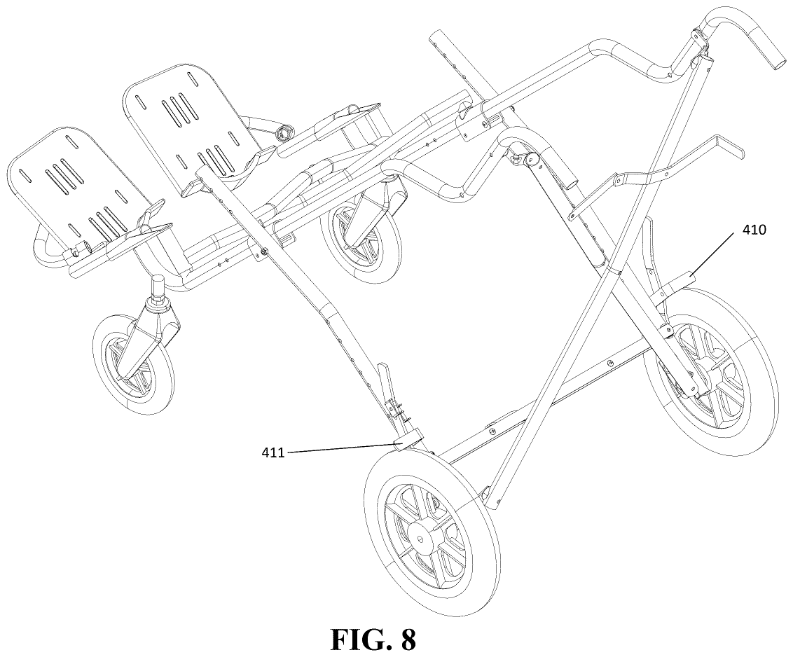

FIG. 8 is an isometric drawing of a wheelchair according to an exemplary embodiment of the invention. As shown in FIG. 8, a wheelchair can have brakes 410 and 411. The brakes can be foot-activated levers such that pressure from an operator's foot can activate the brake. The brake system provides safety functionality by allowing the wheelchair to be securely positioned and preventing unintended movement during transfers, rest periods, or when parked on inclined surfaces.

The foot-activated brake levers 410 and 411 are positioned for convenient access by the wheelchair operator or an attendant. Each brake lever can be independently operated, allowing for selective braking of individual wheels or simultaneous engagement of both brakes for maximum stability. The brake mechanism typically engages with the wheel rims or tire surfaces to provide reliable stopping power and holding force.

In preferred embodiments, the brake levers are spring-loaded to return to the disengaged position when foot pressure is removed, ensuring that the wheelchair remains mobile unless the brakes are intentionally applied. The brake system can include a locking mechanism that allows the brakes to be maintained in the engaged position without continuous foot pressure, which is particularly useful during extended stationary periods.

The brake components are constructed from durable materials capable of withstanding repeated use and environmental exposure. The brake pads or contact surfaces can be replaceable to maintain optimal braking performance over the operational lifetime of the wheelchair. The brake system is designed to function effectively across the range of wheel sizes and tire types that may be used with the wheelchair frame.

The positioning and geometry of the brake levers are optimized to provide adequate mechanical advantage for effective braking while minimizing the force required for operation. This design consideration ensures that users with limited leg strength or mobility can still operate the brake system effectively. The brake levers can also be designed to fold or retract when not in use to prevent interference with the wheelchair's folding mechanism or during transportation in the closed position.

It will be apparent to those skilled in the art that various modifications and variations can be made in the frame for a wheelchair without departing from the spirit or scope of the invention. Thus, it is intended that embodiments of the invention cover the modifications and variations of this invention provided they come within the scope of the appended claims and their equivalents.

What is claimed is:

1. A folding wheelchair comprising:
a plurality of support members each having a first and a second end;
a first support member of the plurality of support members;
a second support member of the plurality of support members;
a third support member of the plurality of support members;
a fourth support member of the plurality of support members;
a fifth support member of the plurality of support members;
a sixth support member of the plurality of support members;
a seventh support member of the plurality of support members;
an eighth support member of the plurality of support members;
a first separation distance measured between the respective first ends of the second support member and the fourth support member;
a second separation distance measured between the respective second ends of the second support member and the fourth support member;
a third separation distance measured between the respective first ends of the first support member and the third support member;
wherein the first support member is rotably connected to the seventh support member
wherein the first support member is slidably connected to the second support member and the sixth support member;
wherein the second support member is rotably connected to the fifth support member and the eighth support member;
wherein the third support member is slidably connected to the fourth support member and the fifth support member;
where in the third support member is rotably connected to the eighth support member;
wherein fourth support member is rotably connected to the sixth and seventh support member;
wherein the fifth support member is rotably connected to the sixth support member;
wherein the seventh support member is rotably connected to the eighth support member;
wherein the wheelchair can be disposed in an open position and a folded position;
wherein in the open position,
the first separation distance is shorter than the second separation distance;
the first separation distance is shorter than the third separation distance;
the second separation distance is shorter than the third separation distance; and
an intersection angle measured at an intersection of the second and fifth support members between their respective first ends, the first intersection angle less than 55 degrees.

2. The folding wheelchair of claim 1 wherein the first intersection angle is 52 degrees.

3. The folding wheelchair of claim 1 wherein, in transitioning from the open position to the folded position,
the first support member rotates about the rotable connection to the seventh support member
the first support slides along the slidable connections to the second support member and the sixth support member;
the second support member rotates about the rotable connection to the fifth support member and the eighth support member;
the third support slides along the slidable connections to the fourth support member and the fifth support member;
the third support member rotates about the rotable connection to the eighth support member;
fourth support member rotates about the rotable connection to the sixth and seventh support member;
the fifth support member rotates about the rotable connection to the sixth support member; and
the seventh support member rotates about the rotable connection to the eighth support member.

4. A headrest for insertion into a seatback pocket of a wheelchair, the headrest comprising:
an insertion portion for insertion into the seatback pocket;
an extension portion for extending out of the seatback pocket for cradling a user's head;
a transition portion between the insertion portion and the extension portion;
a first curvature of the insertion portion, the first curvature sized in relative proportions to match a user's back;
a second curvature of the extension portion, the second curvature sized in relative proportions to match a user's head; and
where in the first curvature and the second curvature are different.

5. The head support system of claim 4 wherein the first curvature of the insertion portion is flatter than the second curvature of the extension portion.

6. The head support system of claim 4 further comprising a removable padded portion covering the extension portion.

7. A head support system for a wheelchair comprising:
the wheelchair;
a head support frame;
an insertion portion of the head support frame;
a head support portion of the head support frame;
a seat back of the wheelchair;
a pocket in the seat back, the pocket sized in relative proportions to slidably receive the insertion portion of the head support frame;
a padded member covering the head support portion of the head support frame;
a first contour of the insertion portion, the first contour sized in approximate proportions to a human back;
a second contour of the head support portion, the second contour sized in approximate proportions to a human head; and
wherein the first contour and the second contour are different.

8. The head support system of claim 7 wherein the head support from is slidably removable from the wheelchair.

9. The head support system of claim 7 wherein the first contour is flatter than the second contour.

10. The head support system of claim 7 further comprising a removable padded portion covering the head support portion.
